(19) United States
(12) Patent Application Publication
(10) Pub. No.: US 2026/0168263 A1
(43) Pub. Date: Jun. 18, 2026

(54) Surface Covering Product and a Method for Preparing the Same

(71) Applicant: Novalis Holdings Limited, Hong Kong (CN)

(72) Inventors: Jin Li, Jiangsu (CN); Kun He, Jiangsu (CN); Yang Chen, Jiangsu (CN); Yujiao Dong, Jiangsu (CN)

(73) Assignee: Novalis Holdings Limited, Hong Kong (CN)

(21) Appl. No.: 19/535,692

(22) Filed: Feb. 10, 2026

Related U.S. Application Data
(63) Continuation of application No. PCT/CN2024/073629, filed on Jan. 23, 2024.

(30) Foreign Application Priority Data
Aug. 10, 2023 (CN) 202311007992.6

(51) Int. Cl. E04F 15/10; B32B 5/18; B32B 5/32; B32B 27/20; B32B 27/30; E04F 15/02

(52) U.S. Cl. CPC E04F 15/107; B32B 5/18; B32B 5/32; B32B 27/20; B32B 27/304; E04F 15/02038; B32B 2250/05; B32B 2250/24; B32B 2255/10; B32B 2255/26; B32B 2264/067; B32B 2264/10; B32B 2266/0235; B32B 2307/536; B32B 2307/54; B32B 2307/584; B32B 2307/72; B32B 2307/7376; B32B 2451/00; B32B 2471/00; E04F 2201/023; E04F 2201/043; E04F 2290/041

(57) ABSTRACT

The present application provides a surface covering product comprising a surface ornamental layer, a buffer layer, a supporting layer, and a backing layer. The surface ornamental layer has a top surface and a bottom surface. The buffer layer is made from a porous material with a top surface and a bottom surface. The supporting layer is made from a foamed polymeric material with a top surface and a bottom surface. The backing layer has a top surface and a bottom surface. The bottom surface of the surface ornamental layer is attached to the upper surface of the buffer layer, the bottom surface of the buffer layer is attached to the top surface of the supporting layer, and the bottom surface of the supporting layer is attached to the top surface of the backing layer.

### CROSS-REFERENCE TO RELATED APPLICATIONS

This application is a continuation of PCT International Application No. PCT/CN2024/073629 filed Jan. 23, 2024, which claims priority under 35 U.S.C. § 119 to Chinese Patent Application No. 202311007992.6, filed Aug. 10, 2023.

### FIELD OF THE INVENTION

This application specifically relates to a surface covering product and a method for preparing the same.

### BACKGROUND

Polyvinyl Chloride (PVC) floorings have gained immense popularity in the market due to their excellent characteristics such as water resistance, wear resistance, design versatility, and stain/chemical resistance. Among PVC flooring categories, the rigid core PVC flooring category has emerged as the fastest-growing category. It retains all the superior characteristics of PVC floorings while demonstrating exceptional performance in terms of dimensional stability, mechanical locking strength, low VOC emissions, and durability in gouge and tear resistance properties. It has become an increasingly popular choice for residential homes and commercial buildings due to its value contributions which earns the product as an alternative to traditional Hardwood, Porcelain tile, Laminate floors, and etc.

There is a flooring panel with a layered structure comprising, from top to bottom, a rigid top layer which comprises a support layer that is substantially composed of a non-foaming material with a higher density, a flexible core layer with voids in form of air pocket and hence having a relatively lower density, and a backing layer. The support layer in the rigid top layer is virtually free from plasticizers and contains CaCO3 as filler material. The thickness of the flexible core layer is smaller than the thickness of the support layer.

There is another flooring product with a layered structure comprising, from top to bottom, a decorative top layer, a compressible layer, and a core layer. The compressible layer comprises at least one intermediate acoustic impedance layer. The decorative top layer has flexibility in the range of 300 to 900 MPa. Furthermore, at least part of an upper surface of the core layer and/or at least part of a lower surface of the core layer comprises a plurality of cavities by impressing.

There is another flooring product with a layered structure comprising, from top to bottom, a coat layer, a wear layer, a decorative top layer, a rigid core layer, a glass fiber layer, and a flexible substrate layer. The adjacent flooring panels are interlocked together by a specially designed tongue/groove mechanical locking system.

There is yet another flooring product with a layered structure comprising a top layer and a rigid substrate layer. The top layer is a layered structure comprising, from top to bottom, a coat layer, a wear layer, a decorative layer, a flexible or a semi-rigid polymer layer, at least one reinforcing layer and an optional backing layer. The rigid substrate layer is based on Portland cement or on magnesium oxide cement. The top layer comprises a polymer layer.

There is yet another flooring product with a layered structure comprising, from top to bottom, a top layer, a secondary substrate layer, an intermediate layer, and a primary substrate layer. The Shore A hardness for the intermediate layer is 10 units lower than the primary and/or secondary substrate layer and at least 10% lower in the Modulus of Elasticity (MOE) than the primary and/or secondary substrate layer.

There is yet another flooring product with a layered structure comprising, from top to bottom, a decorative layer, and a substrate layer. The substrate layer also has a layered structure comprising, from top to bottom, a third non-foamed thermoplastic layer, a second non-foamed thermoplastic layer, a glass fiber reinforced layer, a foamed thermoplastic layer, a glass fiber reinforced layer and a first non-foamed thermoplastic layer. The foaming in the foamed thermoplastic layer is achieved by either a mechanical or chemical foaming process and preferably performed between the pressing belts of a continuous process.

### SUMMARY

The present application is designed to provide a surface covering product, which provides good acoustic performance and/or high content of a renewable material for superior sustainability from an environmentally friendly perspective.

According to the first aspect of the present application, the present application provides a surface covering product comprising a surface ornamental layer, a buffer layer, a supporting layer, and a backing layer. The surface ornamental layer has a top surface and a bottom surface. The buffer layer is made from a porous material with a top surface and a bottom surface. The supporting layer is made from a foamed polymeric material with a top surface and a bottom surface. The backing layer has a top surface and a bottom surface. The bottom surface of the surface ornamental layer is attached to the upper surface of the buffer layer, the bottom surface of the buffer layer is attached to the top surface of the supporting layer, and the bottom surface of the supporting layer is attached to the top surface of the backing layer.

In the surface covering product of the first aspect, the porous material is a renewable composite material with a cellular structure.

In the surface covering product of the first aspect, the porous material is cork with a polymeric binder.

In the surface covering product of the first aspect, the foamed polymeric material is PVC, Polyolefins (PO) or Polyester (PET).

In the surface covering product of the first aspect, the surface covering product further comprises a first bonding layer and a second bonding layer. The bottom surface of the surface ornamental layer is attached to the upper surface of the buffer layer by the first bonding layer. The bottom surface of the buffer layer is attached to the top surface of the supporting layer by the second bonding layer.

In the surface covering product of the first aspect, the bottom surface of the surface ornamental layer is attached to the upper surface of the buffer layer through a hot press lamination process, the bottom surface of the buffer layer is attached to the top surface of the supporting layer a hot press lamination process, and the bottom surface of the supporting layer is attached to the top surface of the backing layer a hot press lamination process.

In the surface covering product of the first aspect, the surface ornamental layer comprises a pre-supporting layer with a top surface and a bottom surface, wherein the Modulus of Elasticity (MOE) for the pre-supporting layer is between that of the buffer layer and the supporting layer, and the hardness for the pre-supporting layer is high than that of the buffer layer.

In the surface covering product of the first aspect, the surface ornamental layer further comprises a coat layer, a wear layer, and a decor layer. The wear layer is attached between the coat layer and the decor layer, the decor layer is attached between the wear layer and the pre-supporting layer, and the top surface of the buffer layer is attached to the bottom layer of the pre-supporting layer.

In the surface covering product of the first aspect, the pre-supporting layer has a Modulus of Elasticity (MOE) no lower than 1500 MPa and a Shore D hardness of 60˜80.

In the surface covering product of the first aspect, the pre-supporting layer is manufactured through the steps including blending, Banbury mixing and calendaring with a formulation comprising PVC 100 phr, CaCO3 300˜450 phr, and at least one plasticizer 12˜17 phr.

In the surface covering product of the first aspect, the thickness of the pre-supporting layer is 0.5˜3.5 mm.

In the surface covering product of the first aspect, the Shore A hardness for the buffer layer is 30˜55.

In the surface covering product of the first aspect, the thickness of buffer layer is 0.5˜4 mm.

In the surface covering product of the first aspect, the density of the buffer layer is 100˜400 kg/m3.

In the surface covering product of the first aspect, the supporting layer has a relatively uniform foaming structure.

In the surface covering product of the first aspect, the density deviation on different spots on the supporting layer is no higher than ±50 kg/m3.

In the surface covering product of the first aspect, the Shore D hardness for the supporting layer is 70˜90.

In the surface covering product of the first aspect, the supporting layer is prepared from a foamed polymeric material with CaCO3 as the filler material, wherein the foamed polymeric material is obtained in an extrusion process.

In the surface covering product of the first aspect, the supporting layer is prepared from foamed polyvinyl chloride (PVC) material with CaCO3 as the filler material, wherein the foamed polyvinyl chloride is obtained in an extrusion process.

In the surface covering product of the first aspect, the supporting layer has PVC 100 phr, CaCO3 100˜400 phr, at least one inorganic foaming agent 1-3 phr, at least one organic foaming agent 1-3 phr and at least one process aid 10˜20 phr, and the supporting layer is prepared through mixing and extrusion processes.

In the surface covering product of the first aspect, the at least one organic foaming agent has an average particle size of no higher than 10 microns.

In the surface covering product of the first aspect, the density of the supporting layer is 1350˜2000 kg/m3.

In the surface covering product of the first aspect, the thickness of the supporting layer is 2˜8 mm.

In the surface covering product of the first aspect, the thickness of the supporting layer is 2˜4 mm.

In the surface covering product of the first aspect, the thickness of supporting layer accounts for 40%˜60^{%} of the total thickness of the surface covering.

In the surface covering product of the first aspect, the supporting layer is free of plasticizers.

In the surface covering product of the first aspect, the backing layer has a Shore A hardness of 15˜55.

In the surface covering product of the first aspect, the backing layer has a foaming porous structure and can be at least partially made from one or any combination of the materials including Polyvinyl Chloride (PVC), Polyolefins (PO), Polyester (PET), Ethylene-vinyl Acetate (EVA), and Polyurethane (PU), and cork.

In the surface covering product of the first aspect, the density of the backing layer is 70˜400 kg/m3.

In the surface covering product of the first aspect, the thickness of the backing layer is 0.5˜2.0 mm.

In the surface covering product of the first aspect, the thickness ratio of the buffer layer to the surface ornamental layer is 0.4:1˜1:1.

In the surface covering product of the first aspect, the thickness ratio of the buffer layer to the supporting layer is 0.1:1˜0.5:1.

In the surface covering product of the first aspect, the supporting layer further comprises coupling structures formed by cutting at least a portion of the supporting layer for coupling adjacent surface covering products of multiple surface covering products. In the surface covering product of the first aspect, the thickness of the surface covering is 4.0˜12.0 mm.

According to a second aspect of the present application, the present application provides a surface covering product comprising a surface ornamental layer, a buffer layer, a supporting layer, and a backing layer. The surface ornamental layer has a top surface and a bottom surface. The buffer layer is made from a porous material with a top surface and a bottom surface. The supporting layer has a top surface and a bottom surface. The backing layer has a top surface and a bottom surface. The bottom surface of the surface ornamental layer is attached to the upper surface of the buffer layer, the bottom surface of the buffer layer is attached to the top surface of the supporting layer, and the bottom surface of the supporting layer is attached to the top surface of the backing layer.

According to a third aspect of the present application, the present application provides a surface covering product comprising a surface ornamental layer, a buffer layer, a supporting layer, and a backing layer. The surface ornamental layer has a top surface and a bottom surface. The buffer layer has a top surface and a bottom surface. The supporting layer is made from a foamed polymeric material with a top surface and a bottom surface. The backing layer has a top surface and a bottom surface. The bottom surface of the surface ornamental layer is attached to the upper surface of the buffer layer, the bottom surface of the buffer layer is attached to the top surface of the supporting layer, and the bottom surface of the supporting layer is attached to the top surface of the backing layer.

According to a fourth aspect of the present application, the present application provides a supporting layer of a surface covering product. The supporting layer is made of a rigid foamed polymeric material comprising a polymeric material 100 phr, CaCO3 100˜400 phr, at least one inorganic foaming agent 1-3 phr, at least one organic foaming agent 1-3 phr, and at least one process aid 10˜20 phr.

In the supporting layer of the fourth aspect, the density deviation on different spots on the supporting layer is no higher than ±50 kg/m3.

In the supporting layer of the fourth aspect, the Shore D hardness of the supporting layer is 80˜95.

In the supporting layer of the fourth aspect, the polymeric material is PVC.

In the supporting layer of the fourth aspect, the at least one inorganic foaming agent is sodium hydrogen carbonate, and the at least one organic foaming agent is azodicarbonamide.

In the supporting layer of the fourth aspect, the at least one organic foaming agent has an average particle size of no higher than 10 microns.

In the supporting layer of the fourth aspect, the process aid is acrylates copolymer.

According to a fifth aspect of the present application, the present application provides a method of producing a surface covering product. The method comprises the steps including: obtaining a surface ornamental layer, a buffer layer made from a porous material, a supporting layer made from a foamed polymeric material and a backing layer; laminating the surface ornamental layer, the buffer layer, the supporting layer and the backing layer together to attach the bottom surface of the surface ornamental layer to the top surface of the buffer layer, attach the bottom surface of the buffer layer to top surface of the supporting layer, and attach the bottom surface of the supporting layer to the top surface of the backing layer; and cutting the opposite lateral sides of the supporting layer to build coupling structures.

In the method of the fifth aspect, obtaining the surface ornamental layer comprises the steps including: obtaining a pre-supporting layer, a wear layer and an decor layer; laminating the pre-supporting layer, the wear layer and the decor layer together to attach the top surface of the decor layer to the bottom surface of the wear layer, and attach the bottom surface of the decor layer to the top surface of the pre-supporting layer (104); and obtaining a coat layer through applying a coating on the top surface of wear layer.

### BRIEF DESCRIPTION OF THE DRAWINGS

The application will be explained in greater details in the following with reference to the embodiments, referring to the appended drawings, in which:

FIG. 1A is a perspective view of an exemplary surface covering product according to this application.

FIG. 1B is a section view along A-A line for FIG. 1A.

FIG. 2A is a perspective view of another exemplary surface covering product according to this application.

FIG. 2B is a section view along A-A line for FIG. 2A.

FIG. 3 is an across-section view exemplarily showing several surface covering products in FIG. 1A coupling together.

FIG. 4A is a flow chart showing the steps for manufacturing the surface covering product according to the present application.

FIG. 4B is a flow chart showing the steps for manufacturing the surface ornamental layer of the surface covering product according to the present application.

### DETAILED DESCRIPTION OF THE EMBODIMENT(S)

This application discloses a broad description of various exemplary embodiments of the application. The description is to be construed as exemplary only and does not describe every possible embodiment, as describing every possible embodiment would be impractical, if not impossible. It will be understood that any feature, characteristic, component, composition, ingredient, product, step, or methodology described herein can be deleted, combined with, or substituted for, in whole or part, any other feature, characteristic, component, composition, ingredient, product, step or methodology described herein. Numerous alternative embodiments could be implemented using either current technology or technology developed after the filing date of this patent while still falling within the scope of the claims. All publications and patents cited herein are incorporated herein by reference.

Unless defined otherwise, all technical and scientific terms used herein have the same meaning as commonly understood by one of ordinary skill in the art to which this application belongs. In case of conflict, the present application including the definitions will control. Also, unless otherwise required by context, singular terms shall include pluralities and plural terms shall include the singular. All publications, patents, and other references mentioned herein are incorporated by reference in their entireties for all purposes.

Unless otherwise specified, when the following abbreviations are used herein, they have the following meaning:

As used herein, the terms “comprises,” “comprising,” “includes,” “including,” “has,” “having,” “contains,” or “containing,” or any other variation thereof, will be understood to imply the inclusion of a stated integer or group of integers but not the exclusion of any other integer or group of integers. For example, a composition, a mixture, a process, a method, an article, or an apparatus that comprises a list of elements is not necessarily limited to only those elements but can include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Also, the indefinite articles “a” and “an” preceding an element or component of the application are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “application” or “present application” as used herein is a non-limiting term and is not intended to refer to any single embodiment of the particular application but encompasses all possible embodiments as described in the application.

The terms “about” and “approximately,” when referring to a numerical value or range are intended to encompass the values resulting from experimental error that can occur when taking measurements. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or subranges encompassed within that range as if each numerical value and sub-range is explicitly recited. For example, a weight range of about 1 weight percentage (wt %) to about 20 weight percentage (wt %) should be interpreted to include not only the explicitly recited concentration limits of 1 wt % to approximately 20 wt %, but also to include individual concentrations such as 2 wt %, 3 wt %, 4 wt %, and sub-ranges such as 5 wt % to 15 wt %, 10 wt % to 20 wt %, etc.

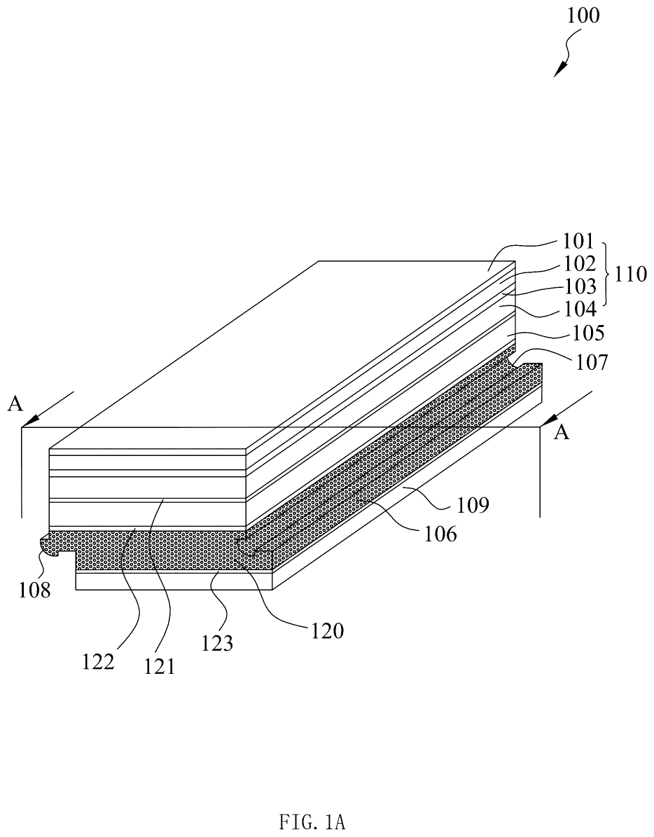

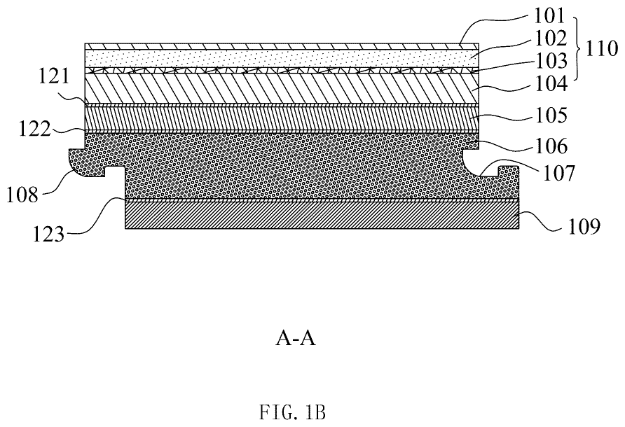

Now with reference to the figures, a surface covering product 100 according to the application is shown in the perspective view in FIG. 1A and the cross-section view in FIG. 1B. Surface covering product 100 has a layered construction comprising a surface ornamental layer 110, a first bonding layer 121, a buffer layer 105, a second bonding layer 122, a supporting layer 106, a third bonding layer 123 and a backing layer 109 arranged from top to bottom. The top surface of the buffer layer 105 is attached to the bottom surface of the surface ornamental layer 110 by the first bonding layer 121, while the bottom surface of the buffer layer 105 is attached to the top surface of the supporting layer 106 by the second bonding layer 122. The bottom surface of supporting layer 106 is attached to the top surface of the backing layer 109 by the third bonding layer 123. In an exemplary embodiment, the surface covering product has a thickness ranging from 4.0 to 12.0 mm.

In an exemplary embodiment of the application, the first boding layer 121 for bonding the surface ornamental layer 110 and the buffer layer 105, the second boding layer 122 for bonding the buffer layer 105 and the supporting layer 106, and the third bonding layer 123 for bonding the supporting layer 106 and the backing layer 109 are adhesive layers. In some embodiments, the first, second and third bonding layers 121, 122 and 123 comprise hard set reactive hot melt adhesives, including but not limited to polyurethane-reactive (PUR) adhesives, two-component AB Epoxy adhesives, or water based adhesives.

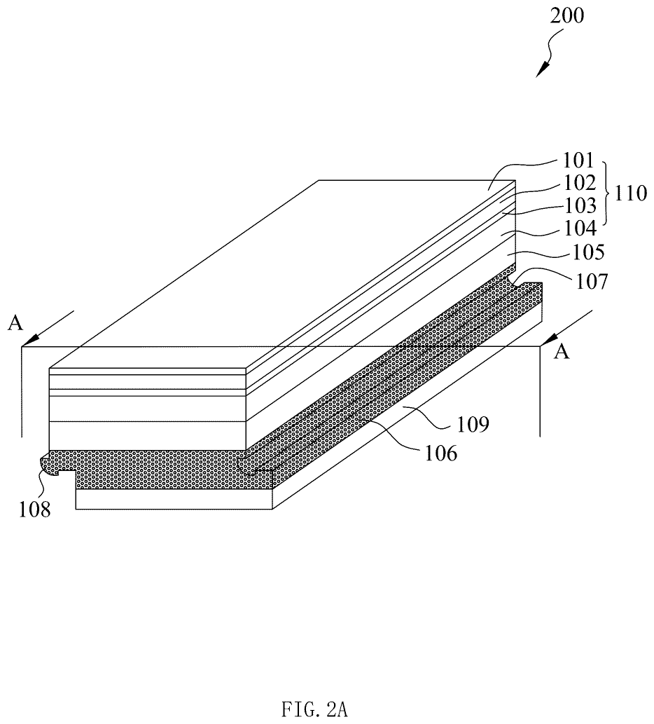

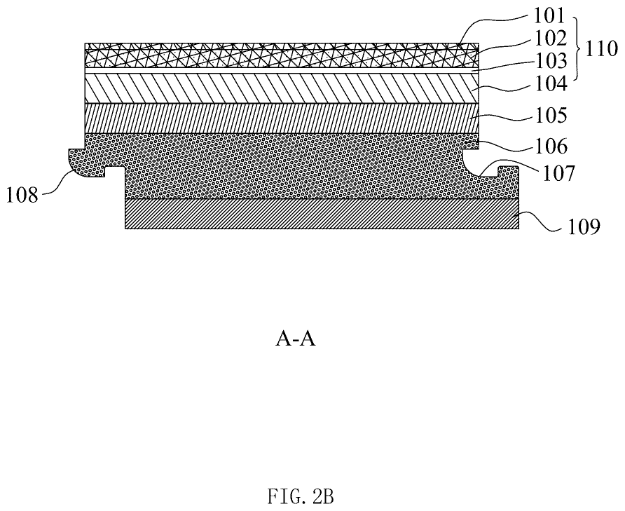

In another exemplary embodiment of this application, a professional skilled of art shall appreciate that the bonding method for bonding the bottom surface of the surface ornamental layer 110 and top surface of the buffer layer 105, between the top surface of supporting layer 106 and bottom surface of buffer layer 105, and between the top surface of backing layer 109 and bottom surface of supporting layer 106, can be at least partially substituted by other means of bond such as but not limited to heat lamination process. FIGS. 2A and 2B illustrate the structure of another exemplary surface covering product 200 produced by bonding the surface ornamental layer 110, the buffer layer 105, the supporting layer 106 and the backing layer 109 via heat lamination process.

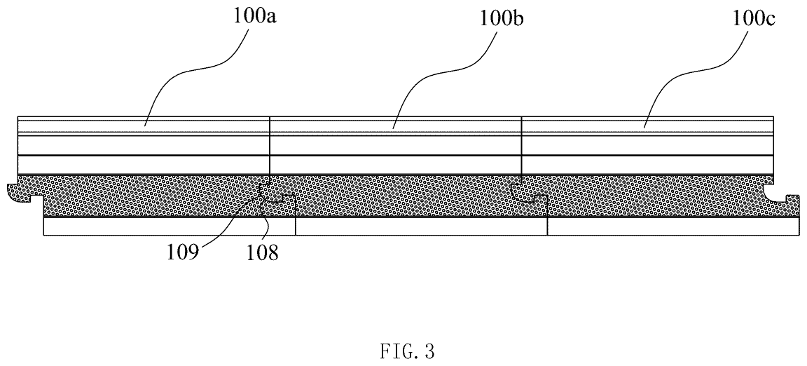

Coupling structures are incorporated into the supporting layer 106 to interlock with the adjacent surface covering products 100. As illustrated in the figures, the coupling structures comprise a tongue structure 108 and a groove structure 107, which are respectively constructed on the opposite lateral sides of the supporting layer 106. The two adjacent surface covering products 100 are joined together by inserting the tongue structure 108 of one surface covering product 100 into the groove structure 107 of the adjacent surface covering product 100. FIG. 3 provides a cross-sectional view of three coupled surface covering products, namely, 100a, 100b, and 100c.

In an exemplary embodiment of the application, the surface ornamental layer 110 has a layered structure including, from top to bottom, a scratch resistant coat layer 101, a wear layer 102, a decor layer 103, and a pre-supporting layer 104. These layers can be bonded by hot press lamination or gluing. In an exemplary embodiment, these layers are bonded together by hot press lamination. The surface ornamental layer 110 provides various properties to the surface covering product 100 including, but not limited to, stain resistance, scratch resistance, abrasion resistance, slip resistance, indentation resistance, tear resistance, and clarity. Additionally, the surface ornamental layer 110 provides aesthetics to the surface covering product 100 including color, gloss, sheen, and decoration features.

In an exemplary embodiment of the application, the coat layer 101 is a wear-resistant radiation-cured topcoat. In an exemplary embodiment, the coat layer 101 is an ultra-violet (UV) curing urethane acrylates system. In an exemplary embodiment, the coat layer 101 is a two-coat matte finish system having a sealer coat (such as Akzo Nobel 971-FJS-388) and a topcoat (such as Akzo Nobel 973-FJS-588). The curing energy to solidify the liquids of the sealer coat and the topcoat is approximately 550 millijoule/cm2 and 1000 millijoule/cm2 respectively. In another exemplary embodiment, the coat layer 101 is a two-coat finish system cured with a 172 nm Excimer UV lamp. In an exemplary embodiment, the thickness of the coat layer 101 is approximately 0.01˜0.1 mm. The coat layer 101 provides the surface covering product 100 with improved surface properties including stain resistance, anti-microbial function, scuff & scratch and abrasive resistance among others.

The wear layer 102 can be produced from polyvinyl chloride (PVC), polyolefins (PO), polyester (PET), polylactic acid (PLA), or other thermoplastic materials. In an exemplary embodiment of the application, the wear layer 102 is made from a transparent PVC composition without containing a phthalate plasticizer component. The transparency of the wear layer 102 allows the aesthetic print on the decor layer 103 to be visible through. Although the thickness of the wear layer 102 may vary, it could be in the range of approximately 0.1 mm to 1 mm. The wear layer 102 provides protection to the aesthetic appearance of the underlying decor layer 103 from foot traffic and other disrupting forces.

In an exemplary embodiment of the application, the composition of the wear layer 102 includes at least one polyvinyl chloride and at least one plasticizer. In some embodiments, the plasticizer is at least one selected from non-phthalate-type plasticizers such as dioctyl terephthalate (DOTP), 1,2-cyclo-hexane dicarboxylic acid diisononyl ester (DINCH), Diethylene glycol dibenzoate (DEGDB), Dipropylene glycol dibenzoate (DPGDB), and a bio-based plasticizer (i.e., a vegetable oil based PVC plasticizer with major components of Octa-decanoic acid, 10-chloro-9-methoxy-, methyl ester). However, one skilled in the art should appreciate that other plasticizers can be used in other embodiments. In an exemplary embodiment of the application, the wear layer 102 also includes at least one stabilizer. In some embodiments, the stabilizer is a non-toxic metal soap stabilizer. In some embodiments, calcium stearate, zinc stearate or the mixture thereof is used as the stabilizer. In an exemplary embodiment of the application, the wear layer 102 further includes at least one co-stabilizer. For instance, the co-stabilizer is an epoxidized soybean oil. In an exemplary embodiment of the application, the wear layer 102 further includes at least one UV light stabilizer. In some embodiment, the UV light stabilizer includes a UV light absorber and a hinder amine to maximize the efficiency of UV light stability. In an exemplary embodiment of the application, the wear layer 102 further includes at least one processing aid. The decor layer 103 can be produced by a printed polyvinyl chloride (PVC) film, printed melamine paper or other printed decorative films. In an exemplary embodiment of the application, the decor layer 103 is a pre-printed PVC film with a thickness ranging from 0.05 to 1.5 mm. In an exemplary embodiment, the thickness of decor layer 103 is about 0.07 mm. The decor layer 103 provides the surface covering product 100 with unique aesthetic design and color.

The Modulus of Elasticity (MOE) of the pre-supporting layer 104 shall be between the buffer layer 105 and the supporting layer 106. The minimum MOE for the pre-supporting layer 104 is 1500 Mpa. In an exemplary embodiment of this application, the MOE for the pre-supporting layer 104 ranges from 1600 to 3000 MPa. The hardness of the pre-supporting layer 104 shall be higher than the buffer layer 105. The Shore D hardness of the pre-supporting layer 104 ranges from 60 to 80. In an exemplary embodiment, the Shore D hardness of the pre-supporting layer 104 is between 70 and 80. The balanced hardness and MOE of the pre-supporting layer 104 provide the surface covering product 100 with excellent indentation resistance and a comfortable foot feel. In an exemplary embodiment, the thickness of the pre-supporting layer 104 ranges from about 0.5 to 3.5 mm. In another exemplary embodiment, the thickness of the pre-supporting layer 104 ranges from about 0.8 mm to 2.0 mm.

In an exemplary embodiment, the pre-supporting layer 104 is produced from a polymeric resin compound with inorganic fillers and additives. The polymeric resin is selected from at least one of thermoplastic materials including, but not limited to, polyvinyl chloride (PVC), polyolefins (PO), polyester (PET), polylactic acid (PLA), or others alike. In an exemplary embodiment, the pre-supporting layer 104 is produced from PVC filled with calcium carbonate (CaCO3) and additives such as at least one non-phthalate plasticizer (or bio-plasticizer) and at least one non-toxic metal soap stabilizer. In an exemplary embodiment, the composition of the pre-supporting layer 104 expressed as parts per hundred parts of polymer resin (“phr”) comprises at least one bio-plasticizer 12 to 17 phr, a soybean oil 2 to 5 phr, calcium carbonate powder 300 to 450 phr, at least one stabilizer 3 to 5 phr, and carbon black 0 to 0.5 phr. In an exemplary embodiment, the polymeric resin in the above composition is PVC.

The buffer layer 105 has Shore A hardness ranging from 30 to 55, measured by durometer per ASTM D2240 method. In an exemplary embodiment, to achieve an optimal balance of indentation resistance and sound insulation, the Shore A hardness of the buffer layer 105 ranges from 35 to 50, and the density ranges from 100 to 400 kg/m³. In another embodiment, the thickness of the buffer layer 105 ranges from 0.5 to 4.0 mm. In yet another embodiment, the thickness of the buffer layer 105 ranges from 0.6 to 1.5 mm. In an exemplary embodiment, the thickness ratio of the buffer layer 105 to the surface ornamental layer 110 is 0.4:1˜1:1. In another embodiment, the thickness ratio of the buffer layer 105 to the surface ornamental layer 110 is 0.45:1 to 0.66:1.

The buffer layer 105 is produced from a porous material. When sound waves enter porous materials, sound energy is dissipated by thermal loss caused by friction of air molecules with the pore walls and viscous loss brought by viscous airflow within the materials. In addition to acoustic benefits, porous materials typically have a lower density and are widely available in natural materials with rich biomass content that can be virtually carbon neutral. In an exemplary embodiment, the buffer layer 105 is made of a renewable composite material with a porous cell structure. In another exemplary embodiment, the buffer layer 105 is made of a natural cellule material. In yet another embodiment, the buffer layer 105 is made of cork which is a closed-cell biological material with a high porous structure filled with air. The buffer layer 105 made of cork greatly contributes to the acoustic performance and sustainability feature of surface covering product 100.

The supporting layer 106 is made of a foamed material. As exemplarily illustrated in FIGS. 1A to 2B, the foamed material has relatively uniform foaming density from center to the side of the foamed material. The density deviation on different spots across the supporting layer 106 is no higher than ±50 kg/m³. The foamed material thus provides the supporting layer 106 with a sturdy foamed structure.

The supporting layer 106 is made of a foamed polymeric material with inorganic fillers and contains zero or small amount (no higher than 2 phr) of plasticizers. The Shore D hardness of the supporting layer 106 ranges from 70-90. The Modulus of Elasticity (MOE) of the supporting layer 106 ranges from 3000 MPa to 7000 MPa. The density ranges from 1350 to 2000 kg/m³ with deviation across the layer no higher than ±50 kg/m³ from aim. In an exemplary embodiment, the density of the supporting layer 106 is 1600˜1800 kg/m³. The density deviation on different spots across the supporting layer 106 is no higher than ±50 kg/m³. The foaming structure of the supporting layer 106 has brought multiple advantages compared with the conventional rigid layers including lower weight (which leads to easy handling and lower transportation cost) and better acoustic performance (i.e., both transmission and sound radiation). In addition, the high uniformity of the foaming structure also endows the supporting layer 106 with decent rigidity and indentation resistance compared with the traditional rigid cores. For ease of installation, coupling structures (or called locking profiles) can be completely built on the lateral sides of the supporting layer 106 and still maintain satisfactory locking strength. In other embodiments, the coupling structure can be extended to other layer or layers of the surface covering product 100. The thickness of the supporting layer 106 can range from 2.0 to 8.0 mm and accounts for 40% to 60% of the thickness of surface covering product 100. In an exemplary embodiment, the thickness of the supporting layer 106 is 2.0 to 3.9 mm. The thickness ratio of the buffer layer 105 to the supporting layer 106 ranges from 0.1:1 to 0.5:1. In an exemplary embodiment, the thickness ratio of the buffer layer 105 to the supporting layer 106 is 0.2:1 to 0.27:1.

In an exemplary embodiment, the supporting layer 106 is made of a rigid foamed polyvinyl chloride (PVC) material. In another exemplary embodiment, the supporting layer 106 is made of a foamed non-PVC polymeric material, such as foamed PET material or foamed polyolefins (PO) material. In another exemplary embodiment, the supporting layer 106 is made of a foamed PVC material which contains zero or small amount of plasticizers (no higher than 2 phr) and calcium carbonate (CaCO3) as the filling material. In another embodiment, the calcium carbonate filler accounts for 70% by weight of the total formulation.

In an exemplary embodiment, the composition of the supporting layer 106 comprises, expressed as parts per hundred parts of polymer resin (“phr”), dry-ground calcium carbonate (CaCO3) 100˜400 phr, at least one inorganic foaming agent 1˜3 phr, at least one organic foaming agent 1˜3 phr, at least one process aid 10˜20 phr. In another embodiment, the composition of the supporting layer 106 also has at least one lubricant and a colorant. In some embodiments, the lubricant comprises at least one internal lubricant 1˜3 phr and at least one external lubricant 1-3 phr. In some embodiments, the inorganic foaming agent is sodium hydrogen carbonate (baking soda), the organic foaming agent is azodicarbonamide, the process aid is acrylates copolymer, the lubricant is polyethylene wax, and the colorant is carbon black. In some embodiments, the average particle size of the organic foaming agent is no higher than 10 microns. In some embodiments, the average particle size of the organic foaming agent is 8-10 microns. The appropriate particle size of the organic foaming agent facilitates the process to achieve uniform air pores size and density distribution. In some embodiments, the composition of supporting layer 106 also contains at least one additional lubricant selecting from oxidized polyethylene, monostearin or the mixture thereof. The foamed structure of the supporting layer 106 has brought light weight features to the product compared to conventional non-foaming products with no need to physically remove mass such as impressing cavities for weight reduction purpose.

The backing layer 109 is made of flexible material with a cellular structure. The Shore A hardness of the backing layer 109 ranges from 15 to 55, the density ranges from 70 to 400 kg/m³, and the thickness ranges from 0.5 to 2.0 mm. In an exemplary embodiment, the density of the backing layer 109 is 100 to 250 kg/m³. In another embodiment, the thickness of the backing layer 109 is 0.7 to 1.5 mm. The cellular structure of backing layer 109 contains both open-cell and closed-cell structures which improve the acoustic performance of surface covering product 100. In addition, the cellular structure can further reduce the total weight of surface covering product 100. In an exemplary embodiment, the backing layer 109 is a foamed flexible material with a cellular structure which can be at least partially made of one or any combination of polyvinyl chloride (PVC), polyethylene (PE), polypropylene (PP), polyolefins (PO), ethylene-vinyl acetate copolymer (EVA), thermoplastic polyurethanes (TPU) and cork.

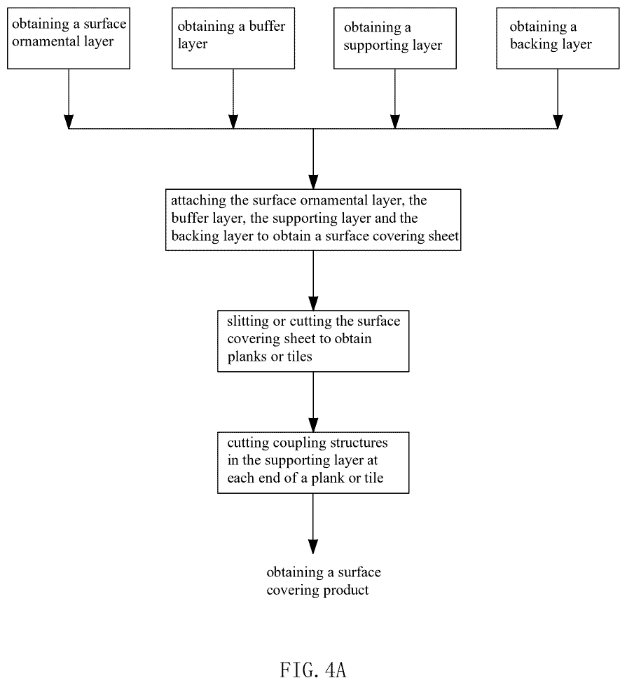

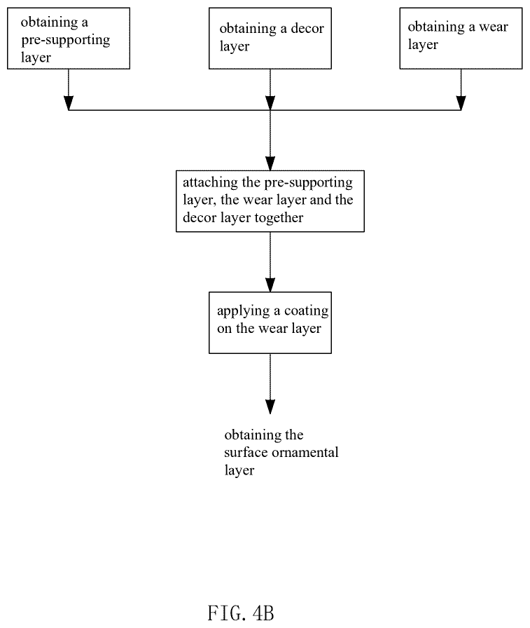

An exemplary procedure for manufacturing the surface covering product 100 is described in FIG. 4A and FIG. 4B, in which FIG. 4A describes the overall manufacturing process for the surface covering product 100 and FIG. 4B describes the manufacturing process for the surface ornamental layer 110. As shown in FIG. 4A, the manufacturing process for the surface covering product 100 is to attach the following pre-produced layers together in the listed sequence, which pre-produced layers include: the surface ornamental layer 110, the buffer layer 105, the supporting layer 106, and the backing layer 109. As described above, the surface ornamental layer 110, the buffer layer 105, the supporting layer 106, and the backing layer 109 are attached to each other either by the first, second and third bonding layers 121, 122 and 133 (see FIGS. 1A and 1B) by a hot melt adhesive gluing process or by a hot press lamination process (see FIGS. 2A and 2B). In an exemplary embodiment, the adhesive forming the first, second and third bonding layers 121, 122 and 133 is selected from hard set reactive hot melt adhesives, two-component AB Epoxy adhesives, water based adhesive or others alike. When using a PUR adhesive, the adhesive is applied by a roller coater with application temperature of 130-150° C., the application weight is 40˜90 gram/m², the adhesive viscosity is about 7000˜12000 MPa·s at 130° C., and the open time is 1˜5 minutes. After the surface ornamental layer 110, the buffer layer 105, the supporting layer 106, and the backing layer 109 are attached together, a surface covering sheet is obtained. Then, the surface covering sheet is slit or cut into desired sizes (i.e., planks or tiles). A surface covering product is obtained by cutting coupling structures in the supporting layer at each end of the planks or tiles.

An exemplary procedure for manufacturing the surface ornamental layer 110 is to first attach the following layers together in the listed sequence: the wear layer 102, the decor layer 103, and the pre-supporting layer 104. Then, the coat layer 101 is applied to the upper surface of the wear layer 102. The final step is to go through an annealing process. The wear layer 102, the decor layer 103, and the pre-supporting layer 104 can be attached to each other by a hot press lamination or gluing process. In an exemplary embodiment, the hot press lamination process is a batch-based hot-pressed process or a continuous roller hot lamination process. The coat layer 101 is an ultra-violet (UV) curing urethane acrylates system applied using a two-pass roller coating process. The sealer coat has an application weight of about 7 to 12 gram/m² and is cured by a UV lamp with curing energy no lower than 350 mj/cm². The top coat has an application weight of about 9 to 15 gram/m² and is cured by a UV lamp with curing energy no lower than 700 mj/cm². After surface coating, the product is further processed through annealing to release the internal stress from the previous processes. Without proper annealing, the dimensional stability of the product may be compromised.

An exemplary procedure for manufacturing the pre-supporting layer 104 starts from mixing the PVC powder, the bio-based plasticizer, the stabilizer, the lubricant, and the colorant in a high-speed mixer until the temperature reaches 70 to 100° C. Then, the mixed materials are discharged into a cold mixer to mix with CaCO3 for 8 to 15 minutes. Then, the mixed materials are discharged into a Banbury mixer including two mixing rotors mounted for rotation in a mixing chamber, as well as a ram mounted for sliding the mixed materials through a passage opening into the mixing chamber. The mixed materials are mixed in the Banbury mixer until the targeted temperature reaches. At this stage, the mixed materials are at a temperature of 150° C. to 215° C. in a hot melt form. The melt is then worked through a hot calendar roll mill. The shear mixing action on the surface of the calendar rollers fluxes the melt and forms a polymer sheet. The thickness of the polymer sheet is controlled by adjusting the distance between the calendar rolls. The sheet is then cooled and collected on a reel or cut into sheets.

The exemplary procedure for manufacturing the supporting layer 106 includes the following steps:
1) All the materials based on the formulation for the supporting layer 106 are accurately fed/dosed into a high shear mixer and mixing for 10-15 minutes till the targeted temperature reaches. Once the mixing material temperature reaches about 120˜140° C., the materials are discharged into a cold mixer and mixed at relatively lower speed for about 10˜20 minutes.
2) The uniformly mixed materials are then fed into a twin-screw extruder for further compounding, plasticization, and foaming. In an exemplary embodiment, the twin screw in the extruder can be either conical or parallel screw configuration. The sufficiently processed and properly foamed materials are pushed by the screw rotation through a slot die and forms a homogeneous polymer sheet with a controlled thickness. In an embodiment, the temperature setting for the extrusion is 160˜220° C. and the exiting material temperature at extrusion die is about 180˜230° C.
3) After the extrusion die, the polymer sheet in a melt status goes through a two-roll mill to further adjust the thickness to target.
4) The sheet with a desired thickness then is conveyed through a cooling bracket, an edge trimming device for width control, and precision cutting into slabs with desired dimensions.

### Example I of the Present Application

In this example, the surface covering product 100 according to this application and as depicted in FIGS. 1A and 1B, was produced with the following properties:

The coat layer 101 is an ultra-violet (UV) curing urethane acrylates system including sealer and topcoat. The target application rate for the sealer and topcoat, respectively, is 10 gram/m2.

The wear layer 102 is made from a transparent PVC composition with DOTP as plasticizer. The target thickness is 0.5 mm.

The decor layer 103 is a pre-printed PVC film with a thickness of 0.07 mm.

The pre-supporting layer 104 has a thickness about 1.0 mm with Shore D hardness about 80 and Modulus of Elasticity (MOE) about 1600 MPa. Table 1 as below discloses an example of the pre-supporting layer composition:

TABLE 1

| Ingredients | Formula (phr) |
|---|---|
| PVC | 100 |
| Bio-based plasticizer | 13-16 |
| CaCO₃ | 300-400 |
| Epoxidized Soybean Oil | 2-4 |
| Calcium Stearate | 1.5-2 |
| Zinc Stearate | 1.0-1.5 |
| Carbon Black | 0.3-0.5 |

*The Bio-based plasticizer used in the Example I comprises a vegetable oil based PVC plasticizer with major components of Octa-decanoic acid, 10-chloro-9-methoxy, methyl ester.

The surface ornamental layer 110 is obtained by laminating the following layers together, from top to bottom, a wear layer 102, a decor layer 103 and a pre-supporting layer 104. A UV coating is then applied on the upper surface of the wear layer 102 to form the coat layer 101.

The buffer layer 105 has a thickness of 1.0 mm and is made from cork with a polymeric binder. Shore A hardness of the buffer layer 105 is 48 and the density of the buffer layer 105 is about 250 kg/m3. Cork is an ideal material for acoustical insulation material due to its unique multi-faced and closed cell honeycomb structure. These cells are filled with air and impermeable to liquids and gases. These cells can deform by compress force but not break, and the cells are resilient and will return to their original shape once the compression force is removed. These many tiny, sealed air pockets can strongly dissipate the sound wave energy generated by the impact of falling objects, footsteps with hard heel or actions alike.

The supporting layer 106 has a thickness about 3.7 mm with a density about 1750 kg/m3, Shore D hardness of 80, and MOE of 3900 MPa. Table 2 as below discloses an example of supporting layer composition.

TABLE 2

| Ingredients | Formula (phr) |
|---|---|
| PVC | 100 |
| DOTP | 0-2 |
| CaCO₃ | 300-350 |
| Calcium-Zinc stabilizer | 7-10 |
| Sodium hydrogen carbonate | 1-1.5 |
| Azodicarbonamide* | 1-1.5 |
| Acrylates Copolymer | 12-16 |
| Monostearin | 1-2 |
| Oxidized Polyethylene | 1-3 |
| Polyethylene Wax | 1-3 |

*The azodicarbonamide has an average particle size of 8~10 microns.

The backing layer 109 in this example is also made from cork with a polymeric binder. The backing layer 109 has a thickness of 1.0 mm.

### Comparative Example I

Following a similar method for manufacturing the surface covering product of Example I of the present application, a so-called stone plastic composite (SPC) surface covering product was produced in line with the most common structure in the market as Comparative Example I to this application.

Essentially, this comparative example of surface covering product has a layered structure including, from top to bottom, a surface ornamental layer, a supporting layer, and a backing layer. The surface ornamental layer in this case consists of a surface coating layer with same UV coating system as Example I of the present application, a same wear layer with a same thickness as Example I of the present application, and a same decor layer (i.e., print layer) as Example I of the present application. Unlike Example I of the present application, the Comparative Example I does not have a pre-supporting layer and a buffer layer. In addition, the supporting layer in this comparative example is different from that the supporting layer 106 of Example I of the present application. The supporting layer in this comparative example is a common SPC core with the formulation as described in Table 3. The thickness of the supporting layer is about 6.0 mm. The backing layer in this comparative example is made of cork with a polymeric bender, which is same as Example I, and has a thickness of 1.0 mm.

TABLE 3

| Ingredients | Formula (phr) |
|---|---|
| PVC | 100 |
| Non-phthalate plasticizer | 0-2 |
| CaCO₃ | 300-350 |
| Calcium-Zinc stabilizer | 8-12 |
| Process aid | 1-3 |
| Impact Modifier | 5-9 |
| Internal lubricant | 1-3 |
| External lubricant | 1-3 |

### Comparative Example II

Following a similar method for manufacturing the surface covering of Example I of the present application, a surface covering product with a layered structure is prepared as Comparative Example II to this application.

Essentially, this comparative example of surface covering product has a layered structure including, from top to bottom, a surface ornamental layer, a buffer layer, a supporting layer, and a backing layer. The surface ornamental layer comprises, from top to bottom, a coat layer, a wear layer, a print layer, and a pre-supporting layer. This example differs from Example I of the present application in the pre-supporting layer, the buffer layer, and the supporting layer.

Specifically, the pre-supporting layer in the Comparative Example II is made from PVC with CaCO3 as filler material and additives including plasticizers. The thickness is 1 mm. The pre-supporting layer has smaller Modulus of Elasticity (MOE) compared to the pre-supporting layer in the Example I of the present application.

The buffer layer in the Comparative Example II is produced from a soft and elastic PP foam material with a thickness of 1.0 mm and a density 200˜300 kg/m3.

The supporting layer in the comparative Example II is produced from a non-foamed PVC material with CaCO3 as filler and no plasticizer. The CaCO3 accounts for about 70% of the weight of the supporting layer. The thickness is 4.0 mm and the density is about 1900˜2100 kg/m3.

The backing layer in the Comparative Example II is produced from cork with a polymeric binder, which is same as the Example I of the present application. The thickness is 1.0 mm.

### Comparative Example III

Following a similar method for manufacturing the surface covering of Example I of the present application, a surface covering product with a layered structure is prepared as Comparative Example III to this application.

Essentially, this comparative example of surface covering product has a layered structure including, from top to bottom, a surface ornamental layer, a buffer layer, a supporting layer, and a backing layer. The surface ornamental layer comprises, from top to bottom, a coat layer, a wear layer, a print layer, and a pre-supporting layer. This example differs from Example I of the present application in the pre-supporting layer, the buffer layer, the supporting layer, and the backing layer.

Specifically, the pre-supporting layer in the Comparative Example III is made from PVC with CaCO3 as filler material and additives including plasticizers. The thickness is 1 mm. The CaCO3 accounts for about 55% of the weight of the pre-supporting layer. The pre-supporting layer has lower rigidity and smaller Modulus of Elasticity (MOE) compared to the pre-supporting layer in the Example I of the present application.

The buffer layer in the Comparative Example III of the present application is produced from a soft and elastic EVA foam material with a thickness of 1.0 mm and a density of 200˜300 kg/m3.

The supporting layer in the Comparative Example III is produced from a non-foamed PVC compound with CaCO3 as filler and no plasticizer. The CaCO3 accounts for about 70% of the weight of the supporting layer. The thickness is 4.5 mm, and the density is about 1900˜2100 kg/m3.

The backing layer in the Comparative Example III is irradiation cross-linked polyethylene (IXPE) foam with a thickness of 1.0 mm and a density 50-100 kg/m3.

### Test Results

All the samples have been subjected to the following tests:
i. The acoustic test was performed in a self-developed acoustic testing facility simulating the impact sound insulation class (IIC) rating according to ASTM E492. A higher IIC means better sound insulation.
ii. Following similar concept as EN 16205 method, acoustic test was performed per self-developed test method to assess the noise radiated from the product while receiving impact. The impact was generated by a dropped steel ball instead of tapping machine as described in EN 16205. A brief description of this test method is provided. The product subjected to test was first acclimated in room temperature (25° C.) for 24 hours. Then the product was placed on a flat surface in a specially constructed room with concrete walls and sealed door which can effectively block the ambient noise. Then a solid steel ball with diameter of 36.5 mm and weight of about 198 grams free fell from 1 meter height onto the deco surface of the test sample. A sound receiving device was placed in a fixed location in the same room and the sound pressure generated by the steel ball impacting on the sample product was measured. Then the sound receiving device would send a signal to a connected computational apparatus to output the result expressed in the unit of decibel (dB). The lower number in this test indicates better acoustic performance in terms of noise radiation.
iii. Residue indentation was performed according to ASTM F1914.
iv. The locking strength test was performed according to ISO 24334. The result is expressed in the unit of kN/m where kN indicates the destruction force of the locking and m indicates the averaged width of the sample surface of the clamped side of the test specimen.
v. The dimensional stability test was performed according to ISO 23999.
vi. The Coefficient of Thermal Expansion (CTE) test was performed according to the test method as described below. The sample subject to test was firstly acclimated in room temperature (25° C.) for 24 hours. After acclimation, the dimension including both machine direction (MD) and Across Machine Direction (AMD) had been measured by caliper. Then the sample was put into oven with a temperature set at 50° C. for 2 hours. After heating, the dimensions in both MD and AMD were immediately measured. Then CTE was calculated based on the dimension changes pre- and post-heating.
vii. Bio-based carbon content was measured according to ASTM D6866-22 Method

The results are shown in Table 4.

TABLE 4

| | | Compar- | Compar- | Compar- |
|---|---|---|---|---|
| | | ative | ative | ative |
| | Exam- | Exam- | Exam- | Exam- |
| Test Items | ple I | ple I | ple II | ple III |
| Density (g/cm³) | 1.41 | 1.72 | 1.66 | 1.45 |
| IIC | 58 | 51 | 58 | 55 |
| Radiated sound by | 87.2 | 93.8 | 91.7 | 91.7 |
| impact (dB) | | | | |
| Residue Indentation | 0.15 | 0.09 | 0.10 | 0.23 |
| (mm) | | | | |
| Locking strength - MD | 4.33 | 4.25 | 4.39 | 4.25 |
| (kN/m) | | | | |
| Locking strength - AMD | 4.06 | 3.94 | 4.02 | 3.91 |
| (kN/m) | | | | |
| Dimensional Stability - | 0.01% | 0.02% | 0.02% | 0.05% |
| MD | | | | |
| Dimensional Stability - | 0.02% | 0.03% | 0.03% | 0.03% |
| AMD | | | | |
| CTE - MD (m/m/° C.) | 4.91E−5 | 3.95E−5 | 4.44E−5 | 3.77E−5 |
| CTE - AMD (m/m/° C.) | 3.75E−5 | 3.89E−5 | 4.09E−5 | 4.95E−5 |
| Bio-based carbon content | 20% | <10%* | 7% | <7%* |

*Calculated based on test result for a product with similar structure and formulation.

Based on the test results listed in the Table 4, it is clearly that the surface covering products according to this application perform better than the comparative examples in acoustic properties including both sound insulation class and sound radiation by impact. In addition, thanks to the unique structure and formulation, the surface covering products according to this application also have a higher bio-based carbon content indicating higher renewable biomass and a lower density compared to the comparative examples. All these improvements have been achieved with satisfactory values for other critical physical properties such as indentation, locking strength, dimensional stability and CTE.

As a summary, the product according to this application has achieved at least the following technical effects:
i. The supporting layer for the product according to this application is made from a rigid foam polymeric material. Compared to a traditional rigid supporting layer, this application has presented clear advantages including light weight, decent rigidity, better acoustic properties, easy handling/transportation, and comfortable feel. In addition, the numerous air pores in the forming structure can positively contribute to the acoustic performance due to rapid dissipation of sound energy while transmitting through these pores.
ii. The density distribution of the rigid foam supporting layer in this application is very uniform thanks to the formulation and process art. This feature endows the supporting layer in this application with similar rigidity compared to a non-foamed supporting layer in a traditional SPC product. In addition, it allows the whole coupling structures to be constructed in the supporting layer without need for extra reinforcing layer or high ratio of the supporting layer thickness to the total product thickness.
iii. The buffer layer according to this application can be made from bio-based renewable material. This feature has significantly increased the biomass content in the product compared to a traditional petroleum-based product. As a result, the carbon footprint can be considerably reduced.
iv. The pre-supporting layer according to this application has a balanced characteristics between rigidity and elasticity due to the hardness and the Modulus of Elasticity (MOE). This rigidity endows the product with satisfactory indentation resistance. And the flexibility ensures acoustic performance.

What is claimed is:

1. A surface covering product, characterized by comprising:
a surface ornamental layer (110) with a top surface and a bottom surface;
a buffer layer (105) made from a porous material with a top surface and a bottom surface;
a supporting layer (106) made from a foamed polymeric material with a top surface and a bottom surface; and
a backing layer (109) with a top surface and a bottom surface;
wherein the bottom surface of the surface ornamental layer (110) is attached to the upper surface of the buffer layer (105), the bottom surface of the buffer layer (105) is attached to the top surface of the supporting layer (106), and the bottom surface of the supporting layer (106) is attached to the top surface of the backing layer (109).

2. The surface covering product according to claim 1, characterized in that the porous material is a renewable composite material with a cellular structure.

3. The surface covering product according to claim 2, characterized in that the porous material is cork with a polymeric binder.

4. The surface covering product according to claim 1, characterized in that the foamed polymeric material is PVC, PO, or PET.

5. The surface covering product according to claim 1, characterized in that the surface ornamental layer (110) comprises a pre-supporting layer (104) with a top surface and a bottom surface, wherein the Modulus of Elasticity (MOE) for the pre-supporting layer (104) is between that of the buffer layer (105) and the supporting layer (106), and the hardness for the pre-supporting layer (104) is higher than that of the buffer layer (105).

6. The surface covering product according to claim 5, characterized in that the surface ornamental layer (110) further comprises:
a coat layer (101);
a wear layer (102); and
a decor layer (103);
wherein the wear layer (102) is attached between the coat layer (101) and the decor layer (103), the decor layer (103) is attached between the wear layer (102) and the pre-supporting layer (104), and the top surface of the buffer layer (105) is attached to the bottom layer of the pre-supporting layer (104).

7. The surface covering product according to claim 5, characterized in that the pre-supporting layer (104) has a Modulus of Elasticity (MOE) no lower than 1500 MPa and a Shore D hardness of 60˜80.

8. The surface covering product according to claim 1, characterized in that the density deviation on different spots on the supporting layer (106) is no higher than ±50 kg/m3.

9. The surface covering product according to claim 1, characterized in that the supporting layer (106) is prepared from a foamed polymeric material with CaCO3 as the filler material, wherein the foamed polymeric material is obtained in an extrusion process.

10. The surface covering product according to claim 9, characterized in that the supporting layer (106) has PVC 100 phr, CaCO3100˜400 phr, at least one inorganic foaming agent 1˜3 phr, at least one organic foaming agent 1-3 phr and at least one process aid 10˜20 phr, and the supporting layer (106) is prepared through mixing and extrusion processes.

11. The surface covering product according to claim 10, characterized in that the at least one organic foaming agent has an average particle size of no higher than 10 microns.

12. The surface covering product according to claim 1, characterized in that the thickness of supporting layer (106) accounts for 40%˜60% of the total thickness of the surface covering (100).

13. The surface covering product according to claim 1, characterized in that the supporting layer (106) is free of plasticizers.

14. The surface covering product according to claim 1, characterized in that the backing layer (109) has a foaming porous structure and can be at least partially made from one or any combination of the materials including Polyvinyl Chloride (PVC), Polyolefins (PO), Polyester (PET), Ethylene-vinyl Acetate (EVA), and Polyurethane (PU), and cork.

15. The surface covering product according to claim 1, characterized in that the thickness ratio of the buffer layer (105) to the surface ornamental layer (110) is 0.4:1˜1:1.

16. The surface covering product according to claim 1, characterized in that the supporting layer (106) further comprises coupling structures formed by cutting at least a portion of the supporting layer (106) for coupling adjacent surface covering products (100) of multiple surface covering products (100).

17. A surface covering product, characterized by comprising:
a surface ornamental layer (110) with a top surface and a bottom surface;
a buffer layer (105) with a top surface and a bottom surface;
a supporting layer (106) made from a foamed polymeric material with a top surface and a bottom surface; and
a backing layer (109) with a top surface and a bottom surface;
wherein the bottom surface of the surface ornamental layer (110) is attached to the upper surface of the buffer layer (105), the bottom surface of the buffer layer (105) is attached to the top surface of the supporting layer (106), and the bottom surface of the supporting layer (106) is attached to the top surface of the backing layer (109).

18. A supporting layer of a surface covering product, characterized in that the supporting layer is made of a rigid foamed polymeric material, wherein the rigid foamed polymeric material comprises:
a polymeric material 100 phr;
CaCO3 100˜400 phr;
at least one inorganic foaming agent 1-3 phr;
at least one organic foaming agent 1-3 phr; and
at least one process aid 10˜20 phr.

19. The supporting layer of a surface covering product according to claim 18, characterized in that the density deviation on different spots on the supporting layer is no higher than ±50 kg/m3.

20. The supporting layer of a surface covering product according to claim 18, characterized in that the polymeric material is PVC;
the at least one inorganic foaming agent is sodium hydrogen carbonate, and the at least one organic foaming agent is azodicarbonamide and has an average particle size of no higher than 10 microns; and
the at least one process aid is acrylates copolymer.
